(19) United States
(12) Patent Application Publication
(10) Pub. No.: US 2006/0142485 A1
(43) Pub. Date: Jun. 29, 2006

(54) Mixtures composed of ethylene-vinyl alcohol copolymers and of crosslinkable rubbers having reactive groups and their use for production of moulded items with good barrier properties

(76) Inventors: Martin Hoch, Heinsberg (DE); Roland Parg, Leverkusen (DE); Rayner Krista, Strathroy (CA); Chia Chu, Coraopolis, PA (US)

Correspondence Address: LANXESS CORPORATION, 111 RIDC PARK WEST DRIVE, PITTSBURGH, PA, 15275-1112, US

(21) Appl. No.: 11/290,166

(22) Filed: Nov. 30, 2005

(30) Foreign Application Priority Data
Dec. 2, 2004 (DE) 10 2004 058 063.4

(51) Int. Cl. C08L 29/04

(52) U.S. Cl. 525/57

(57) ABSTRACT

The invention relates to mixtures composed of ethylene-vinyl alcohol copolymers and of crosslinkable rubbers having reactive groups and their use for production of moulded items with good barrier properties. The inventive mixtures in particular feature the good barrier properties and high impact resistance particularly at low temperatures, with a resultant broad application profile for these mixtures.

The invention relates to mixtures composed of ethylene-vinyl alcohol copolymers and of crosslinkable rubbers having reactive groups and their use for production of moulded items with good barrier properties.

The use of ethylene-vinyl alcohol copolymers, known by the abbreviated term EVOH, in materials with a high level of barrier properties is known. The basis of the barrier properties of the materials comprising ethylene-vinyl alcohol copolymers is that these materials inhibit permeation of gases, of organic liquids and of other low-molecular-weight chemicals. Another advantage of the barrier materials comprising ethylene-vinyl alcohol copolymers is that when these materials are heated or burnt they do not evolve any corrosive gases, whereas this can occur with barrier materials based on polyvinylidene halides or on polyvinyl halides.

Because EVOHs have excellent barrier properties they can also be used in, for example, plastics fuel tanks of automobiles and containers for substances and, respectively, active ingredients requiring special precautions which are intended not to escape into the environment during their storage, for example during storage of pesticides in appropriate bottles, containers or storage tanks.

A disadvantage in using EVOHs as barrier materials is their brittleness. It is therefore obvious that the range of application of ethylene-vinyl alcohol copolymers as barrier materials could be substantially widened if their impact resistance in particular at relatively low temperatures could be considerably improved, this being associated with a reduction in brittleness. In particular in automobile applications, increasingly stringent requirements are placed upon resistance to fuel leakage, and consequently as many as possible of the components in contact with fuel should have a high level of barrier action. On the other hand, for reasons of vibration decoupling, the intention is that many components be, if possible, flexibly rather than rigidly bonded to one another, or intrinsically have some degree of flexibility. The intention is that this be retained even under extreme temperature conditions or on sudden impact.

The industrially known blends of EVOH with other thermoplastics, e.g. with high-density polyethylene (HDPE) or low-density polyethylene (LDPE) have not resulted in substantial improvement of impact resistance at low temperatures with retention of the excellent barrier properties of EVOH.

It was therefore an object to provide ethylene-vinyl alcohol copolymer mixtures which have good impact resistance and flexibility at low temperatures with retention of the excellent barrier properties.

It has now been found that mixtures composed of ethylene-vinyl alcohol copolymers and of crosslinkable rubbers having certain reactive groups are suitable as materials which comply with the abovementioned physical properties and are therefore suitable for use as appropriate flexible barrier materials.

The present invention therefore provides mixtures composed of
a) ethylene-vinyl alcohol copolymers whose content of ethylene groups is from 15 to 60 mol %, whose content of vinyl alcohol groups is from 40 to 85 mol % and whose content, if appropriate, of vinyl ester groups is at most 20 mol % and
b) crosslinkable rubbers whose TG value is ≦−20° C., where the rubbers have been modified with reactive groups and the content of modifying groups is from 0.01 to 5 mol %,
   where the amount of component a) makes up from 30 to 95% by weight, based on the amount of the entire mixture.

Particular preference is given to mixtures composed of from 50 to 95% by weight, very particularly preferably up to 80% by weight, of component a), based on the amount of the entire mixture.

Polymers particularly used as component a) [ethylene-vinyl alcohol copolymers] are those whose content of ethylene groups is from 25 to 50 mol % and whose content of vinyl alcohol groups is up to 75 mol %. The content of vinyl ester groups should preferably be in the range from 0 to 20 mol %, in particular in the range from 0 to 5 mol %.

The residual content of vinyl ester groups of the ethylene-vinyl alcohol copolymers is in practice based on the fact that the ethylene-vinyl alcohols are usually prepared via hydrolysis of ethylene-vinyl acetate copolymers. In the case of incomplete hydrolysis, an appropriate residue of vinyl ester groups remains in the copolymer.

Rubbers suitable as component b) [crosslinkable rubbers] are those whose TG value is in particular ≦−25° C., very particularly preferably ≦−35° C.

Examples of these rubbers are: ethylene-α-olefin copolymers whose content of ethylene is from about 30 to 80% by weight, preferably from 40 to 75% by weight, and, as α-olefin, propylene, butylene, hexene, and octene, preference being given to ethylene-α-olefin copolymers and very particular preference being given to copolymers based on ethylene and propylene. These copolymers may also contain up to 15% by weight of diene components, composed, for example, of ethylidenenorbornene, dicyclopentadiene or hexadiene.

Another important feature of the crosslinkable rubbers to be used is that they have reactive groups, the content of these preferably being in the range from 0.02 to 4 mol %, in particular from 0.02 to 3 mol %. It is also possible to use mixtures composed of rubbers where only one rubber component contains reactive groups and thus provides effective linkage of the phases. By way of example, it is possible to use mixtures composed of ethylene-propylene elastomer having reactive groups and of such materials without any reactive group.

Reactive, functional groups which may be used are those which can react with the alcohol groups of component a). Examples of those suitable are carboxy groups, anhydride groups, sulphonyl chloride groups, carbonyl chloride groups, isocyanate groups, and epoxy groups. Anhydride groups are preferred.

Possible ways of incorporating the reactive groups into the rubbers are copolymerization with appropriate monomers or appropriate reactions on the rubber, for example a graft reaction. By way of example, it is possible to use an appropriate graft reaction of maleic anhydride with an ethylene-α-olefin rubber in solution or in the melt, to prepare the ethylene-α-olefin rubbers whose use is preferred in appropriate modified form via appropriate mixing processes in the presence of free-radical-generating initiators, such as peroxides.

As mentioned, the crosslinkable rubbers preferably used as component b) for the inventive mixtures are those which have, as reactive groups, a content of from 0.2 to 3 mol % of maleic anhydride groups, and which are based on ethylene-propylene copolymers whose content of ethylene is from 45 to 75% by weight.

Of course, it is possible for the inventive mixtures also to be blended with other components, such as PE, in particular HDPE, with polyamides, and with copolyamides, and the selection of the components here and of their amount depends on the subsequent use of the inventive mixtures, a limiting factor to be considered in relation to amounts being the homogeneity of the inventive mixtures. A factor which has to be considered here is that it has to be ensured that the thermoplastic of component a) provides the continuous phase or at least has a lamellar structure within the blend, thus ensuring the presence of an effective permeation barrier.

The T_{g} values of the rubber phase in the inventive mixtures (measured via DSC are in the region of −20° C. and below, preferably not higher than −30° C.

The present invention also provides the use of the inventive mixtures for production of moulded items which have excellent barrier properties, combined with good impact resistances and with excellent flexibility at low temperatures. Examples which may be mentioned of appropriate moulded items are:

Lines, connectors, adapters or fuel tanks, intended to prevent outward migration of fuel, lubricating oils, cooling fluids and other liquids, and gases, e.g. hydrogen. Another result can be protection of thermoplastic materials from stress-cracking failure as a consequence of contact with organic liquids.

The inventive materials can therefore be used in the sector of automobile components, where features desired are not only high solvent resistance and permeation barrier but also high flexibility. Other products which may be mentioned are lines and seals in cooling assemblies, and in the automobile sector, and also, for example, in the cooling of buildings. Flexible barrier materials of this type are also highly desirable in fuel cell technology. Because these blends can also be adhesive-bonded to suitable rubber vulcanisates, the result can also be combinations of rubber and plastics components. It is also possible to show here how these rubber vulcanisates have to be structured in order to achieve particularly high adhesion.

Processing is possible using the processes conventional in the thermoplastics industry, such as (co)extrusion, injection moulding, extrusion blow moulding and press vulcanization, using appropriate compounded rubbers. Processing together with other thermoplastics, such as HDPE, PA, PBT, polycarbonate and with other materials known as engineering plastics, is particularly typical. A decision has to be made in each case here as to whether tie-layer materials also have to be used to improve adhesion to the other thermoplastic materials. It is also possible to process the inventive blends together with thermoplastic vulcanisates, the resultant overall effect being to manufacture highly flexible components with a high barrier by means of thermoplastic processing methods.

### EXAMPLES

Materials Used:

EVOH: Eval® L101 B, ethylene-vinyl alcohol copolymer having 27 mol % of ethylene and an MFI value of 4 g/10 min at 190° C. and 2.160 kg load, produced by Eval Europe.

MAH-g-EP(D)M:

Trial product KA 8962, an amorphous ethylene-propylene copolymer whose ethylene content is 48% by weight and whose content of grafted-on maleic anhydride is 2% by weight, and whose MFI value is 26 at 190° C./5.2 kg of load, and whose Tg is −58° C. (DSC), produced by Lanxess Corp.

Trial product KA 8944, a crystalline ethylene-propylene copolymer whose ethylene content is 68% by weight and whose content of grafted-on maleic anhydride is 0.8%, whose ML 1+8 Mooney value is 62 Mooney units at 125° C., and whose MFI value is 16 at 230° C./21.6 kg of load, and whose Tg is 47° C. (DSC), produced by Lanxess Corp.

Exxelor® 1803: an amorphous ethylene-propylene copolymer whose ethylene content is 48% and whose content of grafted-on maleic anhydride is 0.5%, and whose MFI value is 3 at 230° C./10 kg of load, and whose Tg is −45° C. (DSC), produced by ExxonMobil Chemicals

Grilon® BFZ 3: an elastomer-modified polyamide from Ems-Chemie, recommended for use in agrochemicals containers.

### Experiments

Materials Testing:

Notched impact resistance (Charpy, ISO 179 le), notched 80×10×4 mm³ flat specimens as supplied at various temperatures on a falling-pendulum apparatus with registration capability, support separation 40 mm, drop height 50 cm, peen diameter 4 mm.

Puncture Resistance:

Measurements on rectangular test specimens of 60×60 mm to ISO 6603-2

Tensile test: at room temperature using a Zwick-Roell test machine on S2 specimens, crosshead velocity 5 mm/min, registration of tensile strain by means of video-extensometer

### Experiments 1-4

The mixtures were prepared in a DSM mini-kneader (Midi 2000 Xplore microcompounder, internal volume 18 ml, 2 corotating screws) at 100 rpm.

75 parts of L101B EVOH were blended here with 25 parts of maleated EPM and 0.3 part of Irgafos® 168 as stabilizer. The mixing temperature was 250° C.

The melts obtained were directly injection moulded into attached moulds to obtain test specimens. The phase structure was determined via measurement of the shear modulus curves at from −150 to 250° C. at a frequency of 1 Hz.

| Experiment | KA 8962 | Exxelor 1803 | KA 8944 | No modifier |
|---|---|---|---|---|
| No. | 1 | 2 | 3 | Comparison 1 |

Phase structure

| | | | | | |
|---|---|---|---|---|---|
| Tg- soft phase | [° C.] | −62 | −58 | −56 | — |
| Tg - EVOH | [° C.] | 66 | 63 | 62 | 66 |
| Tm - EVOH | [° C.] | (132)/187 | (136)/188 | (128)/186 | (126)/188 |
| G′corr, EVOH (RT) ¹ | [MPa] | 1230 | 1120 | 1265 | 1665 |

Notched impact test 80 × 10 × 4 mm³ test specimens

| | | | | | |
|---|---|---|---|---|---|
| Ak (RT) | [kJ/m²] | 66.0 ± 2.1 | 9.7 ± 2.5 | 49.0 | 5.2 ± 0.1 |
| Fmax (RT) | [N] | 465 ± 20 | 350 ± 25 | 430 | 370 ± 15 |
| Ak (10° C.) | [kJ/m²] | 57.0 | — | 38.2 | — |
| Fmax(10° C.) | [N] | 480 | — | 470 | — |
| Ak (0° C.) | [kJ/m²] | 18.6 | — | 13.8 | — |
| Fmax (0° C.) | [N] | 535 | — | 450 | — |
| Ak −(20° C.) | [kJ/m²] | 17.3 ± 3.5 | 5.4 ± 1.3 | 13. ± 0.8 | 2.9 ± 0.3 |
| Fmax (−20° C.) | [N] | 540 ± 15 | 325 ± 35 | 470 ± 5 | 355 ± 30 |

Tensile strain on S2 specimens

| | | | | | |
|---|---|---|---|---|---|
| Tensile strength | [MPa] | 58 ± 6 | 36 ± 8 | 61 ± 7 | 84 ± 2 |

¹ G′corr, EVOH (RT): = G′specimen (RT)/G′specimen (−125° C.) * G′EVOH (−125° C.)

Ak is notched impact res., Fmax is maximum force in the fracture curve.

Comparison of these blends shows that the use of rubbers with high content of maleic anhydride groups and with minimum glass transition temperature has a particularly advantageous effect on high notched impact resistance.

### Experiment 5

KA 8962 and EVOH were mixed in a corotating twin-screw extruder (L/D 32) at a ratio by weight of 25:75 and 97 rpm. The material was extruded in the form of a strand with a throughput of 10 kg/h, cooled by passage through a water bath, and chopped to give pellets. The melt temperature during extrusion was 256° C., and the barrel temperature was from 225 to 238° C.

The pellets were then processed to give test specimens using an Arburg injection moulding machine.

Notched impact resistance was determined to Izod notched (ISO 180-IA) for each selected temperature on 10 test specimens.

In the table below, the values indicated in bold mean brittle fracture, whereas the other values relate to ductile fracture.

Notched impact resistance kJ/m2 at various temperatures, 10 specimens in each case

| Temp. ° | | | | | | | | | | | Aver- |
|---|---|---|---|---|---|---|---|---|---|---|---|
| C. | 1 | 2 | 3 | 4 | 5 | 6 | 7 | 8 | 9 | 10 | age |
| −40 | 22.7 | 26.1 | 24.4 | 25.4 | 23.0 | 24.1 | 22.3 | 25.1 | 20.3 | 22.3 | 23.6 |
| −30 | 25.8 | 26.5 | 25.8 | 26.1 | 34.7 | 31.3 | 27.8 | 30.9 | 28.9 | 33.7 | 28.2 |
| −20 | 81.8 | 80.8 | 82.2 | 85.6 | 86.3 | 88.9 | 80.8 | 75.3 | 80.4 | 81.1 | 81.8 |
| 0 | 92.5 | 94.9 | 94.9 | 94.5 | 97.6 | 95.6 | 98.0 | 100.7 | 95.9 | 95.9 | 96.0 |
| 23 | 97.3 | 96.9 | 98.0 | 98.3 | 96.6 | 98.7 | 94.2 | 100.7 | 93.8 | 95.6 | 97.0 |

The temperature curve for the notched impact resistances shows that the brittle-tough transition of this blend lies at from −20 to −30° C. Even in the temperature range (e.g. −40° C.) in which brittle fracture is found, notched impact resistance is markedly above the values found for pure EVOH. This permits compliance with requirements such as those demanded in the automobile sector.

### Experiment 6 (Comparative Example 2)

Using a method the same as that in Experiment 5, test specimens were produced and tested using Grilon BFZ 3. The following results were obtained here:

| | Notched impact resistance | |
|---|---|---|
| | (average value from 10 | Nature of |
| Temperature. ° C. | determinations, ISO 180-1A), | fracture |
| 23 | 53.6 kJ/m2 | ductile |
| −20 | 35.5 kJ/m2 | ductile |
| −30 | 16.1 kJ/m2 | brittle |
| −40 | 14.6 kJ/m2 | brittle |

The notched impact tests clearly show that the toughness of the inventive blends has increased sharply when comparison is made with the unmodified comparison (pure EVOH, Comparison 1).

It is also clear that mixtures using a twin-screw extruder give values better than those in the mini-mixer.

The twin-screw extruder represents the process typically used industrially for preparation of polymer blends. The data show that almost no alternation of notched impact resistance occurs from RT to −20° C. The brittle-tough transition occurs at about −30° C. When comparison is made with the elastomer-modified polyamide (Grilon BFZ 3), which represents the prior art for impact modification for polyamide, the result here is, surprisingly, a clear improvement in the case of the thermoplastic EVOH.

### Experiment 7

Puncture test using the blend from Experiment 5 (EN ISO 6603-2)

Test temperature

| | −20° C. | RT | |
|---|---|---|---|
| Maximum force Fmax | 5029 | 4070 | N |
| Deformation at Fmax | 11.5 | 13.8 | mm |
| Total energy | 36.8 | 41.1 | J |
| Total deformation | 13.1 | 16.8 | mm |

Puncture resistance therefore remains substantially identical at from RT to −20° C., and it can therefore be concluded that strength remains the same within this temperature range, i.e. flexibility is retained even at low temperature.

### Experiment 8

Pellets from Experiment 5 were extruded by the cast method at 210° C. to give a foil.

EVAL L101B EVOH was likewise extruded to give foils.

The resultant foils were used to determine hydrogen permeation:

Hydrogen permeation determination, Mocon tester, 1000 mbar of H2,
dry, 23° C., detection by pressure-measurement capacitor

| | | | Permeation, |
|---|---|---|---|
| | | | standardized |
| | | Gas permeability | cm3 100μ/ |
| Foil | Thickness | cm3/(m2 d bar) | (m2 d bar) |
| Eval L101B, foil | 63μ | 6.9 | 4.4 |
| | 71μ | 5.4 | 3.8 |
| Blend from | 119μ | 8.6 | 10.2 |
| Experiment | | | |
| 5, foil | | | |
| | 125μ | 8.3 | 10.3 |

The permeation values of various grades of EVOH may be stated for comparison:

Soamol having 29 mol % of ethylene: 27 cm3 20μ/m2 d bar (5.4 cm3 100μ/m2 d bar)

Soarnol having 32 mol % of ethylene: 32 cm3 20μ/m2 d bar (6.4 cm3 100μ/m2 d bar)

Soarnol having 44 mol % of ethylene: 195 cm3 20μ/m2 d bar (39 cm3 100μ/m2 d bar)

(from: Soarnol Technical Note “Hydrogen Gas Barrier Property of Soarnal”).

Hydrogen migrates particularly rapidly because of its small molecular size and can have an important role in new drive systems, e.g. in fuel cells.

It can be concluded that the barrier to gas or solvent provided by the inventive blends is similar to that provided by the pure EVOH materials. The inventive blends therefore belong to the group of the high-barrier materials, but also have the desired advantages of excellent flexibility.

### Experiment 8

### Adhesion of Inventive Blends to Rubber Vulcanisates

Compounded materials 1-5 were prepared in internal mixers in the usual manner.

| | | Compounded | |
|---|---|---|---|
| | | material No. | |
| | | 1 | 2 |
| Therban ® KA 8882, hydrogenated | Lanxess AG | 75 | |
| nitrile rubber for low-temperature | | | |
| applications | | | |
| Therban ® KA 8889, hydrogenated | Lanxess AG | 25 | |
| nitrile rubber having carboxy groups | | | |
| Corax N 550, carbon black | Degussa AG | 40 | |
| Vulkasil A1, medium-reinforcement | Lanxess AG | 15 | |
| precipitated sodium aluminium silicate, | | | |
| BET surface area (m2/g) 45-75 | | | |
| Sartomer ® SR 633, zinc diacrylate | Goebel & Pfrengle | 35 | |
| Vulkanox ® ZMB2/C5, zinc methyl- | Lanxess AG | 0.5 | |
| mercaptobenzimidazole | | | |
| TAIC ®, triallyl isocyanurate, coagent | Kettlitz Chemie GmbH&Co. KG | 1 | |
| PERKADOX ® 14-40 B-GR, 1,3-bis | Akzo Nobel Chemicals GmbH | 7 | |
| (tert-butylperoxyisopropyl)benzene | | | |
| Naugard ® 445, aryl diphenylamine | Crompton | 1.2 | |
| antioxidant | | | |
| Struktol ® ZP - 1014, zinc peroxide | Schill + Seilacher | 4 | |
| Levapren ® −700 HV, ethylene-vinyl- | Lanxess AG | | 100 |
| acetate copolymer whose VA content is | | | |
| 70% by weight and whose ML 1 + 4 | | | |
| Mooney value, 100° C., is 27 | | | |
| Armeen ® 18 D Prills, oleylpropylene- | Akzo Nobel Chemicals GmbH | | 2 |
| diamine | | | |
| Silquest ® RC-1 silane | GE Silicones | | 4 |
| TRONOX ® R-U-5, titanium dioxide | Kerr-McGee Pigments GmbH & | | 5 |
| | Co. KG | | |
| Vulkasil ® S, precipitated silica whose | Bayer AG Dormagen | | 40 |
| BET surface area is (m2/g) from 155 to | | | |
| 195 | | | |
| OMYA ® BSH, calcium carbonate | Omya GmbH | | 40 |
| Martinal ® H10A, aluminium hydroxide | Martinswerke | | 130 |
| Rhenofit ® TAC/S, triallyl cyanurate | Rhein Chemie | | 0.5 |
| PERKADOX ® 14-40 B-GR | Akzo Nobel Chemicals GmbH | | 6 |

Compounded
material No.

| | | 3 | 4 |
|---|---|---|---|
| Buna ® EPG 2440, EPDM, Mooney | Lanxess AG | 100 | |
| viscosity (ML (1 + 4) 125° C.) 24, ENB | | | |
| content (%) 4, ethylene content (%) 51) | | | |
| Regal ® SRF N 772, carbon black | Cabot GmbH | 50 | 50 |
| Zinc oxide aktiv | Lanxess AG | 5 | 5 |
| Vulkanox ® HS/LG, 2,2,4-trimethyl-1,2- | Lanxess AG | 0.5 | 0.5 |
| dihydroquinoline, polymerized, TMQ | | | |
| Rhenofit ® TRIM/S, trimethylolpropane | Rhein Chemie | 2 | 2 |
| trimethacrylate. Bonded with activated | | | |
| silica | | | |
| PERKADOX ® BC-40 B-PD | Akzo Nobel Chemicals | 7 | 7 |
| | GmbH | | |
| Buna ® EPG 3850, EPDM, Mooney | Lanxess AG | | 100 |
| viscosity (ML (1 + 4) 125° C.) 28, ENB | | | |
| content (%) 8, ethylene content (%) 48) | | | |

| | | Compounded |
|---|---|---|
| | | material No. |
| | | 5 |
| Buna ® EP G 3850 | Lanxess AG | 75 |
| KA 8962 | Lanxess AG | 25 |
| Regal ® SRF N 772, carbon black | Cabot GmbH | 50 |
| Zinc oxide aktiv | Lanxess AG | 5 |
| Vulkanox ® HS/LG | Lanxess AG | 0.5 |
| Rhenofit ® TRIM/S | Rhein Chemie | 2 |
| PERKADOX ® BC-40 B-PD | Akzo Nobel Chemicals GmbH | 7 |

Specimens for adhesion testing were produced by vulcanizing, in the press, sheets composed of compounded rubbers having the stated composition with interleaved foil composed of the blend from Experiment 5.

The thickness of the foil was 100 p. The vulcanization conditions were 10 minutes at −180° C.

To determine adhesion, strips of width 2 cm were stamped out, and the two strips were peeled apart at an angle of 180°, using a tensile testing machine.

For comparison, these experiments were repeated with a foil based on pure Eval L101 B EVOH whose thickness was 100μ.

| | Elastomer, | | |
|---|---|---|---|
| Compounded | vulcanization | Peel force in N | Peel force |
| material No. | system | Foil from Ex. 5 | in N EVOH |
| 1 | Carboxylated HNBR, | 30 | 35 |
| | peroxide, | | |
| | Zn diacrylate | | |
| 2 | EVM, peroxide | 20-25 | 23 |
| 3 | EPDM, peroxide | 5 | 2.5 |
| 4 | EPDM, peroxide | 4.5 | 2 |
| 5 | EPDM, maleated, | >25 | not |
| | peroxide | | determined |

The results show that the inventive blends exhibit high adhesion to compounded rubbers if foils of the blends are vulcanized together with compounded rubbers in the press. These experiments show that it is possible to produce composites from rubber vulcanisates and thermoplastics. The use of extruded foils in the experiments described is, of course, a simplification for easier conduct of the experiments. In fact, it is possible to use any of the processing methods in which the barrier material is brought into contact with a vulcanizable compounded rubber under melt-processing conditions. This is the case when the two materials are brought into contact with one another in extrusion processes. If a moulding of the barrier material is combined after shaping with the compounded rubber, as in the inventive examples, the vulcanization temperature required together with the vulcanization time provide the necessary adhesion conditions.

An example of a possible industrial design of the process can use coextrusion of barrier material, if appropriate of other thermoplastic materials, and of a compounded rubber, and subsequent vulcanization, as is conventional for hoses and lines. By way of example, the inventive blend can be the core of a flexible solvent hose. Adhesion is high when polar rubbers are used. It is also possible to add, to the compounded rubbers, elastomers having maleic anhydride functions or carboxylic acid groups, in order to achieve high adhesion to the inventive blends. This is in particular necessary when the elastomers are non-polar, an example being EPDM. Examples of polar rubbers are ethylene-vinyl acetate copolymers having high vinyl acetate contents of 40% by weight and above, or else ethylene-acrylate copolymers having high acrylate contents of 50% by weight and above, or else polyacrylates.

Non-polar elastomers, such as EPM or EPDM, have to be modified via polar groups, and it is sufficient here merely for a portion of the elastomer in the compounded rubber to have been modified. The contents of the reactive groups should be at least 0.02 mol %, preferably at least 0.05 mol %. Reactive groups which may be used, as for the preparation of the inventive thermoplastic blends, are those which can react with the alcohol groups of component a). Examples of suitable groups are therefore carboxy groups, anhydride groups, sulphonyl chloride groups, carbonyl chloride groups, isocyanate groups, and epoxy groups. Anhydride groups are preferred.

Among the polar or reactive compounded rubbers suitable for adhesion are also thermoplastically processable vulcanisates (TPVs) and, respectively, elastomers (TPEs), as long as these have appropriate reactive groups (at least 0.02 mol %) or comprise at least 50% by weight of polar rubbers, as defined above.

Blends according to the invention permit production of containers with barrier properties thus permitting minimization not only of the permeation of oxygen into the container but also of permeation of volatile compounds out of the container. These containers with the inventive blends can then resist impact at low temperature, for example the impacts which can occur during handling in cold stores and in particular with large-volume packs.

1. Mixtures composed of
a) ethylene-vinyl alcohol copolymers whose content of ethylene groups is from 15 to 60 mol %, whose content of vinyl alcohol groups is from 40 to 85 mol % and whose content, if appropriate, of vinyl ester groups is at most 20 mol % and
b) crosslinkable rubbers whose T_{G} value is ≦−20° C., where the rubbers have been modified with reactive groups and the content of modifying groups is from 0.01 to 5 mol %,
where the amount of component a) makes up from 30 to 95% by weight, based on the amount of the entire mixture.

2. Mixtures according to claim 1, where component b) has been modified with an anhydride function.

3. Mixtures according to claim 1, where component b) has been modified with a carboxylic acid function.

4. Use of the mixtures according to any of claims 1 to 3 for production of moulded items with good barrier properties.

5. Use of the mixtures according to any of claims 1 to 3 for production of mouldings, in particular of multilayered containers, pipes, lines, hoses, connectors, sheets and foils.

6. Materials composites at least composed of mixtures according to any of claims 1 to 5, which have been firmly adhesive-bonded with crosslinked compounded materials based on polar rubbers or on reactive rubbers according to b).

7. Materials composites at least composed of mixtures according to any of claims 1 to 5, which have been firmly adhesive-bonded with crosslinked compounded materials based on polar rubbers of ethylene-vinyl acetate-copolymer type having vinyl acetate contents of 40% by weight and above, or of ethylene-acrylate-copolymer type having at least 50% by weight acrylate content, or of polyacrylate type.
